(19) United States
(12) Patent Application Publication
(10) Pub. No.: US 2002/0091541 A1
(43) Pub. Date: Jul. 11, 2002

(54) Method and apparatus for intellectual property management on the internet

(75) Inventor: Steven W. Lundberg, Edina, MN (US)

Correspondence Address: Schwegman, Lundberg, Woessner & Kluth, P.A., P.O. Box 2938, Minneapolis, MN, 55402, US

(73) Assignee: SEEKIP.com

(21) Appl. No.: 09/882,846

(22) Filed: Jun. 15, 2001

Related U.S. Application Data
(60) Provisional application No. 60/212,241, filed on Jun. 16, 2000.

(51) Int. Cl. G06F 17/60

(52) U.S. Cl. 705/1

(57) ABSTRACT

There is disclosed method, software and apparatus for creating a user portfolio of IP asset records. Such portfolios can be created by searching existing records to find a group, adding records one at a time, or automatically adding records using a watch function. Other management or analysis tools can be applied to manage user portfolios.

### TECHNICAL FIELD OF THE INVENTION

The present invention pertains generally to computers, and more particularly to method, apparatus and software for use in managing intellectual property using the Internet.

### BACKGROUND OF THE INVENTION

Information concerning intellectual property assets such as patents, trademarks and copyrights is typically stored in databases that can be searched and queried. For example, databases representative of these assets are now widely available on the Internet, and much of the basic data can be obtained free of charge. These public databases, for example the Internet database of patents and trademarks sponsored by the United States Patent & Trademark Office or the European Patent Office, contain records representative of a large number of the patents or trademarks that are processed by these organizations.

In managing or working with intellectual property assets, it is often desirable to maintain a database of IP assets that for example belong to a certain organization or group of organizations, typically termed a “portfolio.” A portfolio may be organized according to ownership rights or other attributes such as a group of patents or trademarks having a relationship to one another, or simply a group of IP assets that a user desires to group together for the purpose of management, manipulation, analysis or other objectives. While Internet databases of IP assets allow access to and operation on individual assets such as a single patent, they have not provided a system for conveniently assembling a plurality of IP asset records from a database into smaller groups such as but not limited to a portfolio of IP asset records representative of patents or trademarks or other IP owned by a particular organization. Further, there has not been provided a means for assembly such portfolios conveniently and then managing them using the assembled records.

### BRIEF DESCRIPTION OF THE DRAWINGS

FIGS. 1 illustrates one example illustration of a system according to the invention.

FIGS. 2-6 illustrate various example embodiments of the methods of the invention.

### DETAILED DESCRIPTION OF THE INVENTION

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only be the appended claims.

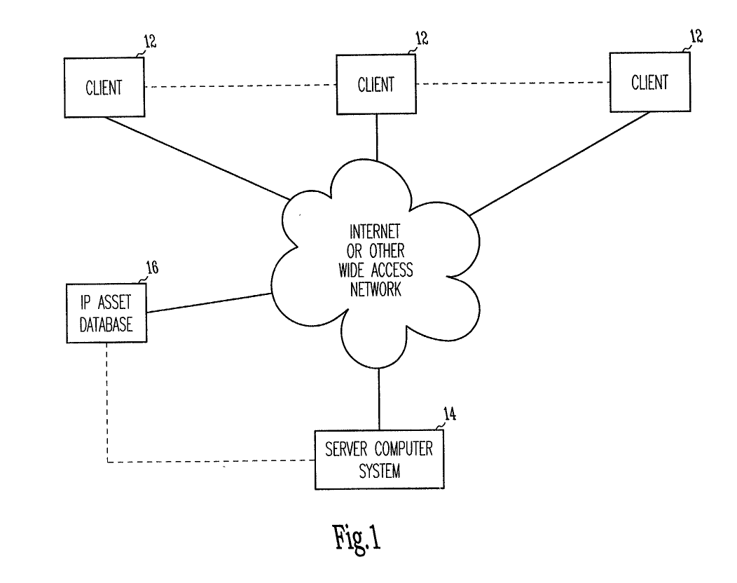

Referring now to FIGS. 1 and 2 there is illustrated an Internet-based method for organizing records into user portfolios. As shown in FIG. 1, the system 10 includes a plurality of client computers 12 such as personal computers, workstations or Internet appliances that include HTML or JAVA based browsers or other software capable of interacting with a server computer system 14, through a wide access network 16, such as the Internet in one example embodiment. Using the method of FIG. 2, a user operating a client computer 12 can access and build a user portfolio database of records representative of IP assets such as patents, trademarks or other IP assets. As will be illustrated below, the portfolio can be assembled by several different techniques all managed from a client computer user interface, which is an HTML or JAVA based language in one example embodiment. These techniques include retrieving or selecting a set of IP asset records from a source database of IP asset records 16 (FIG. 1) for example including all patents or trademarks issued or handled by an organization such as the United States Patent & Trademark Office, or the European Patent Office, or any other country's patent and trademark offices. This set can then be groomed (by deletion of unwanted records selected in the query) to form a part or all of the desired user portfolio database of IP asset records. Additional records can be added to this database by specifying them one at a time, or another group can be selected by executing an additional search for a group of additional records using different search criteria. For example, a first group of records based on a first owner can be retrieved and groomed and added to the user portfolio. Another group could similarly be retrieved and added to the portfolio. In addition, records can be added to the database one at a time, for example specified by patent number or trademark registration number. Moreover, in another embodiment, records which are added to the source database or databases can be automatically identified by recurrent searches of the source database. These records can be identified according to one or more additional criteria, and staged and presented to the user for approval to add to the portfolio, or simply added to the portfolio automatically. By this mechanism, a user can assemble a portfolio containing records of past issued patents or trademarks and also automatically have this portfolio updated.

For example in particular, a corporation with hundreds of IP assets can use the system of the present invention to quickly search out all existing records in a source database or databases, groom the records to eliminate unwanted records such as those that were retrieved but do not belong in the portfolio, customize the database one records at a time to add any miscellaneous IP assets they hold, and then set the system up so that it continues to update the portfolio automatically. A portfolio of records so comprised can in addition be used to manage the associated IP assets or records, as described further below.

Referring now to FIG. 2, a method according to one example embodiment 20 is illustrated in more detail. A user enters into a client computer on the Internet one or more first criteria for a search of an IP database (22). This source IP database can be kept, in one example embodiment, on a server computer system on the Internet and containing records of intellectual property assets owned by a plurality of different owners. The source IP database is then searched for records matching the one or more criteria (24). The client computer displays to the user on the client computer a list of records found in the search (26). The user can optionally reject, using the client computer, selected records in the list, for example by checking off records from a list. (28). The non-rejected records are added to a user portfolio database (30). According to one embodiment, this search and groom operations are done in one session such that a user can quickly assemble a core group of records within a short period of time such as five minutes to a couple of hours (or more), depending on the number of records retrieved in the search.

Records can be added to the user portfolio database by simply maintaining a pointer to the records in the source database are also part of the portfolio, or by making a separate copy of the records, or by other means. The user can add additional records to the user portfolio database one at a time by identifying intellectual property assets one at a time using the client computer (32), for example by identifying records by a patent or trademark number.

The user can also specify, using the client computer, one or more additional search criteria for an IP database, the search criteria being the same as or different from the first criteria (34), and the server computer system uses the additional search criteria to automatically search (36) the IP database on a recurring basis on at least some of the days following the original search. These search results are displayed to the user, on the client computer, as a list of records found in the additional searches (38), for example each time a user logs on to the system, and the user can optionally reject selected records in the list using the client computer (40), with the non-rejected records being added to the user portfolio database (42). Such additional records can be alternatively added to the database automatically 44 and later pared from the database using a grooming function that allows a user at any time to delete unwanted records from the portfolio 46.

In one example embodiment, the user portfolio database maintains bibliographic data for each asset such as the filing date, application or serial number, the inventor or applicant, the owner, an abstract, or other such basic asset information. Alternatively, a full copy of the entire record offered in the source database can be copied into the user portfolio database. When adding individual patents to a user portfolio, a user can simply specify one criteria such as patent number or application number, and the remaining bibliographic data will be automatically retrieved from the source database and added to the user portfolio database if desired.

According to one example embodiment, a user may add a published paper to the user portfolio database as an IP asset. Further, the system of present invention can be programmed to watch for additional papers published by a particular author, in accessible source databases of such publications. Such subsequently identified assets can be processed as indicated above to add to the user portfolio.

According to one example embodiment, some of the records added to the user portfolio database correspond to records of IP assets maintained in a source database such as the USPTO's database, while other records in the user portfolio database pertain to IP assets that are not represented in such databases such as a pending U.S. patent application. Furthermore, according to one example embodiment, a record found in a source database during a recurring update search, such as a newly issued U.S. patent record, may correspond to a record in the user portfolio database that is representative of the filed application for that patent. In such a case, the serial/application number of the application as may be stored in the user portfolio record can be matched to the serial/application number of the issued patent, and the record of the application can be updated to indicate the patent is issued, such that duplicate records are avoided.

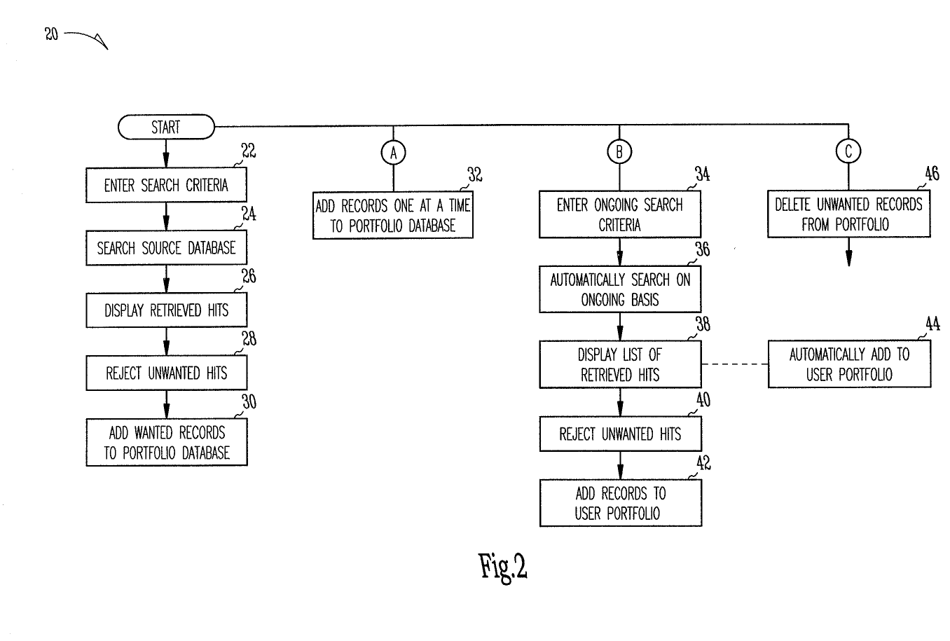

According to other embodiments 50 of the invention illustrated in FIG. 3, the user portfolio database can be used to manage or analyze IP assets represented by the database. For example, according to one embodiment, a user can request 52 that a watch service be performed for all the watchable IP assets in the portfolio, or for one or more individual IP assets 54. For instance, a user may request that a citation watch be performed for all patents represented in the user portfolio. In a citation watch, a source database is monitored on a going forward basis to identify any subsequently issued patents that cite back to the watched patent, for example if the watched patent is identified as prior art to the subsequently issued patent. For this function, the source database must contain information which specifies some or all of the references cited against the application. According to one example embodiment, a user may add a published paper to the user portfolio database as an IP asset, and a watch of subsequently issued patents can attempt to determine if the paper was cited against any of the subsequently issued patents. Further, the system of present invention can be programmed to watch for additional published papers that cite to the watched paper.

According to another watch service embodiment, all trademarks in a portfolio can be watched to determine if later filed or published trademarks are similar, commonly known as a trademark watch. In this watch, the trademarks of subsequently issued trademarks are analyzed to determine if they are similar to the trademarks specified in the user portfolio database.

According to one example embodiment, the watch services are automatically performed on the server computer system for a plurality of different IP assets in the user portfolio and the results are presented to a user with the client computer. These watch results themselves be saved and if desired, an indication of the relationship to the watched term can be maintained for future reference.

According to another example embodiment 60 shown in FIG. 4, docketing information is maintained 62 on the server computer system (and optionally a copy on the client computer) and is presented on the client computer for one or more of the IP assets in the user portfolio database 64. The docketing information can be renewal or maintenance or annuity docketing information. The docketing information may also include fees owed for an IP asset and the dates such fees are owed. Further the system can optionally present to the user on the client computer status or reports indicating upcoming docketing events or payments due for annuities or maintenance. Further, a user can optionally be allowed to elect to pay or not pay annuities or maintenance fees 66 and such election can be used by others having access to the system, or used automatically or semi-automatically, to provide for payment of such fees. Of course, the docketing information may also concern the renewal or maintenance of a trademark. The system can also, in one example embodiment, collect from a user on a client computer information required to perform a legal service with respect to an IP asset in a user portfolio database 68. Such required information might be trademark use information required information is renewal or maintenance information for a trademark, or information required for maintenance of a patent.

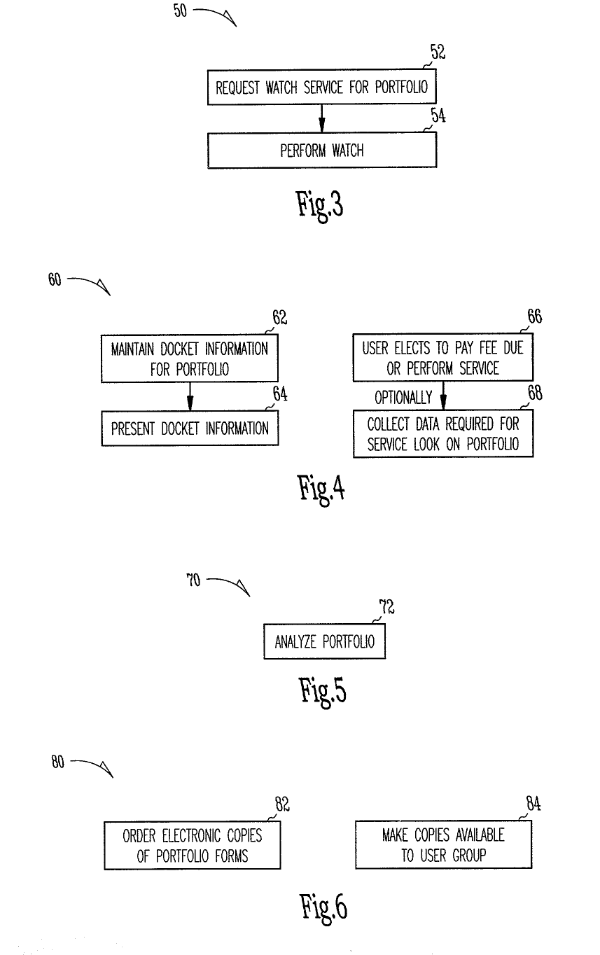

According to yet another example embodiment 70 shown in FIG. 5, data analysis or processing regarding one or more IP assets in the user portfolio database can be performed, either on the server computer system, or the client computer 72. Such analysis might, for example, determine the number of patents held in a particular art area, or the number of patents to expire in a given year.

According to yet another example embodiment 70 illustrated in FIG. 6, a user can order electronic or paper copies of documents pertaining to one or more of the IP assets in the user portfolio database, using a client computer 72. A user can optionally request on the client computer that electronic copies of documents pertaining to one or more IP assets in the user portfolio be made available for access by the user or group of users sharing an account 84. One additional embodiment of the invention provides for displaying to the user on the client computer a user activated indicia associated with one or more IP assets in the user portfolio database that allows the user to view an electronic image of a document associated with an IP asset in the user portfolio database. Further, according to one embodiment, the electronic copies are owned by the user and can be downloaded by the user, and are kept in PDF format. According to one example embodiment, the server computer system includes one or more computing or storage devices, and such devices may be located together or in different locations. The computing device can be, without limitation, a personal computer or a workstation computer or an Internet appliance.

According to one example embodiment, the server computer system 4 uses JAVA and/or HTML-based languages to interact with a client computer 7, with the user portfolio databases being maintained on the server computer system 14. The system 14 provides for displaying on the client computer the controls required to accomplish the functions specified above, and in particular controls that provide that a user can create, build, display and use a user portfolio database. In one example embodiment, the system 14 provides an account for each user which is password protected. Within each account, a user can create and maintain one or more user portfolio databases. For example, a user may create a patent user portfolio database of patents owned by the user's company, and a separate trademark user portfolio database of trademarks owned by the user's company.

Further, according to one example embodiment, each record in a user portfolio has associated with it a number of management or other functions that can performed for or on the asset, wherein such functions can be selected or manipulated by displaying a list of the records in the database and by selecting or deselecting checkboxes or other such controls (typically in an HTML format). For example, a check box may be provided for each asset record to control whether or not a watch is provided for the asset.

Furthermore, according to another example embodiment, the invention comprises a computer program embodied in a machine readable media comprising computer instructions that perform the functions descried above, either in the server computer system 14 or client computers 12.

Thus, there has been described above method, systems and software that allow for creating user portfolios of database records representative of IP assets, and use such portfolios to manage or analyze or otherwise use the IP assets.

In the claims:

1. An Internet-based method, comprising:
a user entering into a client computer on the Internet one or more first criteria for a search of an IP database kept on a server computer system on the Internet and containing records of intellectual property assets owned by a plurality of different owners;
searching the IP database for records matching the one or more criteria;
displaying to the user on the client computer a list of records found in the search;
allowing the user to optionally reject, using the client computer, selected records in the list;
adding non-rejected records to a user portfolio database;
the user adding additional records to the user portfolio database one at a time by identifying intellectual property assets one at a time using the client computer;
the user specifying, using the client computer, one or more additional search criteria for an IP database, the search criteria being the same as or different from the first criteria;
the server computer system using the additional search criteria to automatically search the IP database on a recurring basis on at least some of the days following the original search;
displaying to the user, on the client computer, a list of records found in the additional searches;
allowing the user to optionally reject selected records in the list using the client computer; and
adding non-rejected records to the user portfolio database.

2. A method according to claim 1 including automatically performing a watch service for at least one of the IP assets in the user portfolio.

3. A method according to claim 1 including automatically performing a watch service on the server computer system for a plurality of different IP assets in the user portfolio and presenting watch results to a user with the client computer.

4. A method according to claim 1 further including keeping docketing information on the server computer system and presenting docketing information on the client computer for one or more of the IP assets in the user portfolio database.

5. A method according to claim 4 further wherein the docketing information is renewal or maintenance or annuity docketing information.

6. A method according to claim 5 wherein the docketing information includes fees owed for an IP asset and the dates such fees are owed.

7. A method according to claim 4 further wherein the docketing information concerns the renewal or maintenance of a trademark.

8. A method according to claim 4 further including displaying to a user docketing status information for one or more IP assets.

9. A method according to claim 1 further including collecting from a user on a client computer information required to perform a legal service with respect to an IP asset in a user portfolio database.

10. A method according to claim 9 wherein the required information is renewal or maintenance information for a trademark.

11. A method according to claim 10 wherein the required information pertains to maintenance of a patent.

12. A method according to claim 1 further including performing data analysis or processing regarding one or more IP assets in the user portfolio database.

13. A method according to claim 1 further including a user ordering electronic or paper copies of documents pertaining to one or more of the IP assets in the user portfolio database.

14. A method according to claim 1 further including a user requesting on the client computer that electronic copies of documents pertaining to one or more IP assets in the user portfolio be made available for access by the user.

15. A method according to claim 1 further including displaying to the user on the client computer a user activated indicia associated with one or more IP assets in the user portfolio database that allows the user to view an electronic image of a document associated with an IP asset in the user portfolio database.

16. A method according to claim 14 wherein the electronic copies are owned by the user and can be downloaded by the user.

17. A method according to claim 16 wherein the electronic copy is a PDF format copy.

18. A method according to claim 1 wherein the server computer system includes one or more computing or storage devices.

19. A method according to claim 18 wherein the computing devices and storage devices are located in different locations.

20. A method according to claim 1 wherein the client computer is a personal computer or a workstation computer or an Internet appliance.

21. A method according to claim 1 wherein the search criteria are owners or assignees of the IP assets.

22. An Internet-based on-line system comprising:
a client computer on the Internet enabled to allow a user to enter one or more first criteria for a search of an IP database kept on a server computer system on the Internet and containing records of intellectual property assets owned by a plurality of different owners;
the server computer enabled to search the IP database for records matching the one or more criteria;
the client computer enabled to display to the user on the client computer a list of records found in the search;
the client computer enabled to allow the user to optionally reject selected records in the list;
the server computer system enabled to add non-rejected records to a user portfolio database;
the client computer enabled to allow a user to request additional records be added to the user portfolio database one at a time by identifying intellectual property assets one at a time using the client computer;
the client computer enabled to allow a user to specify one or more additional search criteria for an IP database, the search criteria being the same as or different from the first criteria;
the server computer system enabled to use the additional search criteria to automatically search the IP database on a recurring basis on at least some of the days following the original search;
the client computer enabled to display to the user a supplementary list of records found in the additional searches;
the client computer enabled to allow the user to optionally reject selected records in the supplementary list using the client computer;
the server computer system enabled to add non-rejected records to the user portfolio database.

23. A system according to claim 22 including the server computer system enabled to automatically perform a watch service for at least one of the IP assets in the user portfolio.

24. A system according to claim 22 including the server computer system enabled to automatically perform a watch service for a plurality of different IP assets in the user portfolio and presenting watch results to a user with the client computer.

25. A system according to claim 22 further including the server computer system enabled to retain docketing information and to present docketing information on the client computer for one or more of the IP assets in the user portfolio database.

26. A system according to claim 25 further wherein the docketing information is renewal or maintenance or annuity docketing information.

27. A system according to claim 25 wherein the docketing information includes fees owed for an IP asset and the dates such fees are owed.

28. A system according to claim 25 further wherein the docketing information concerns the renewal or maintenance of a trademark.

29. A system according to claim 25 further including the server computer system enabled to display on a client computer docketing status information for one or more IP assets.

30. A system according to claim 22 further including the client computer enabled to collect from a user computer information required to perform a legal service with respect to an IP asset in a user portfolio database.

31. A system according to claim 30 wherein the required information is renewal or maintenance information for a trademark.

32. A system according to claim 31 wherein the required information pertains to maintenance of a patent.

33. A system according to claim 22 further including the server computer system enabled to perform data analysis or processing regarding one or more IP assets in the user portfolio database.

34. A system according to claim 22 further including a client computer system enabled to allow a user to order electronic or paper copies of documents pertaining to one or more of the IP assets in the user portfolio database.

35. A system according to claim 22 further including the client computer enabled to allow a user to request that electronic copies of documents pertaining to one or more IP assets in the user portfolio be made available for access by the user.

36. A system according to claim 22 further including the server computer system enabled to cause the client computer to display to the user a user activated indicia associated with one or more IP assets in the user portfolio database that allows the user to view an electronic image of a document associated with an IP asset in the user portfolio database.

37. A system according to claim 36 wherein the electronic copies are owned by the user and can be downloaded by the user.

38. A system according to claim 37 wherein the electronic copy is a PDF format copy.

39. A system according to claim 22 wherein the server computer system includes one or more computing or storage devices.

40. A system according to claim 39 wherein the computing devices and storage devices are located in different locations.

41. A system according to claim 22 wherein the client computer is a personal computer or a workstation computer or an Internet appliance.

42. A method according to claim 1 wherein the a hypertext markup language is used to display information on a client computer.

43. Apparatus according to claim 1 wherein the client computer is enabled to display information to a user in response to a hypertext markup language.

44. A method according to claim 1 wherein the server computer system sends programming information to the client computer using JAVA computer language instructions or commands.

45. Apparatus according to claim 1 wherein the server computer system is enabled to send programming information to the client computer using JAVA computer language instructions or commands.

46. A computer program embodied in a machine readable media comprising computer instructions that perform any one of the methods set forth in claims 1-21.
